(19) United States
(12) Patent Application Publication
(10) Pub. No.: US 2025/0220387 A1
(43) Pub. Date: Jul. 3, 2025

(54) SOUND SPACE CONSTRUCTION DEVICE, SOUND SPACE CONSTRUCTION SYSTEM, STORAGE MEDIUM STORING PROGRAM, AND SOUND SPACE CONSTRUCTION METHOD

(71) Applicant: Mitsubishi Electric Corporation, Tokyo (JP)

(72) Inventors: Tomoharu AWANO, Tokyo (JP); Kosuke HOSOYA, Tokyo (JP); Isamu OGAWA, Tokyo (JP)

(73) Assignee: Mitsubishi Electric Corporation, Tokyo (JP)

(21) Appl. No.: 19/087,040

(22) Filed: Mar. 21, 2025

Related U.S. Application Data
(63) Continuation of application No. PCT/JP2022/036165, filed on Sep. 28, 2022.

(51) Int. Cl. H04S 7/00; H04R 1/32

(52) U.S. Cl. CPC H04S 7/40; H04R 1/32; H04S 2400/11

(57) ABSTRACT

A sound space construction device includes processing circuitry. The processing circuitry acquires audio data including audio from sound sources, determines sound source positions as positions of the sound sources based on the audio data, generates pieces of extraction audio data by extracting audio represented by the audio data in regard to each sound source and generating the extraction audio data representing the extracted audio, generates stereophonic sounds corresponding to the sound sources by converting a format of the pieces of extraction audio data to a format of stereophonic audio, acquires an auditory position where audio is listened to, calculates an angle and a distance between the auditory position and each sound source position, adjusts each stereophonic sound by using the angle and the distance corresponding to each h sound source position and thereby generates adjusted stereophonic sounds as stereophonic sounds at the auditory position, and superimposes the adjusted stereophonic sounds together.

### CROSS REFERENCE TO RELATED APPLICATION

This application is a continuation application International Application No. PCT/JP2022/036165 having an international filing date of Sep. 28, 2022, all of which is hereby expressly incorporated by reference into the present application.

### BACKGROUND OF THE INVENTION

### 1. Field of the Invention

The present disclosure relates to a sound space construction device, a sound space construction system, a storage medium storing a program, and a sound space construction method.

### 2. Description of the Related Art

Development of stereophonic technology is in progress at present. For example, by using an Ambisonics method, a sound field in 360-degree directions at a microphone position can be reproduced. In order to implement the Ambisonics method, an Ambisonics microphone is generally used. If the Ambisonics microphone is fixed, when an experiencer moves freely in a virtual space, the sound field at the place after the movement cannot be reproduced.

In regard to this issue, Patent Reference 1 discloses a device suitably designed so as to correct directional characteristics of captured directional audio in response to spatial data of a microphone system that captures the directional audio. With this device, the directional characteristics of the directional audio depending on movement of a viewing/listening position can be corrected.

Patent Reference 1: Japanese Patent Application Publication No. 2022-509761

However, in the conventional technology, when there are two or more sound sources, space tracking in the Ambisonics B-format in regard to the movement of the viewing/listening position cannot be performed.

Therefore, an object of one or a plurality of aspects of the present disclosure is to make it possible to reproduce the sound field at a free position in the state in which a sound collection device is fixed.

### SUMMARY OF THE INVENTION

A sound space construction device according to an aspect of the present disclosure includes processing circuitry to acquire audio data including audio from a plurality of sound sources, to determine a plurality of sound source positions as positions of the plurality of sound sources based on the audio data, to generate a plurality of pieces of extraction audio data by extracting audio represented by the audio data in regard to each sound source and generating the extraction audio data representing the extracted audio, to generate a plurality of stereophonic sounds corresponding to the plurality of sound sources by converting a format of the plurality of pieces of extraction audio data to a format of stereophonic audio, to acquire an auditory position as a position where audio is listened to, to calculate an angle and a distance between the auditory position and each of the plurality of sound source positions, to adjust each of the plurality of stereophonic sounds by using the angle and the distance corresponding to each of the plurality of sound source positions and thereby generate a plurality of adjusted stereophonic sounds as a plurality of stereophonic sounds at the auditory position, and to superimpose the plurality of adjusted stereophonic sounds together.

A sound space construction system according to an aspect of the present disclosure includes the sound space construction device and a sound collection device that is connected to the sound space construction device by a network and generates audio data including audio from a plurality of sound sources.

A non-transitory computer-readable storage medium according to an aspect of the present disclosure stores a program that causes a computer to execute processing to acquire audio data including audio from a plurality of sound sources, to determine a plurality of sound source positions as positions of the plurality of sound sources based on the audio data, to generate a plurality of pieces of extraction audio data by extracting audio represented by the audio data in regard to each sound source and generating the extraction audio data representing the extracted audio, to generate a plurality of stereophonic sounds corresponding to the plurality of sound sources by converting a format of the plurality of pieces of extraction audio data to a format of stereophonic audio, to acquire an auditory position as a position where audio is listened to, to calculate an angle and a distance between the auditory position and each of the plurality of sound source positions, to adjust each of the plurality of stereophonic sounds by using the angle and the distance corresponding to each of the plurality of sound source positions and thereby generate a plurality of adjusted stereophonic sounds as a plurality of stereophonic sounds at the auditory position, and to superimpose the plurality of adjusted stereophonic sounds together.

A sound space construction method according to an aspect of the present disclosure includes acquiring audio data including audio from a plurality of sound sources, determining a plurality of sound source positions as positions of the plurality of sound sources based on the audio data, generating a plurality of pieces of extraction audio data by extracting audio represented by the audio data in regard to each sound source and generating the extraction audio data representing the extracted audio, generating a plurality of stereophonic sounds corresponding to the plurality of sound sources by converting a format of the plurality of pieces of extraction audio data to a format of stereophonic audio, acquiring an auditory position as a position where audio is listened to, calculating an angle and a distance between the auditory position and each of the plurality of sound source positions, adjusting each of the plurality of stereophonic sounds by using the angle and the distance corresponding to each of the plurality of sound source positions and thereby generating a plurality of adjusted stereophonic sounds as a plurality of stereophonic sounds at the auditory position, and superimposing the plurality of adjusted stereophonic sounds together.

According to one or a plurality of aspects of the present disclosure, the sound field at a free position can be reproduced in the state in which the sound collection device is fixed.

### BRIEF DESCRIPTION OF THE DRAWINGS

The disclosure will become more fully understood from the detailed description given hereinbelow and the accompanying drawings which are given by way of illustration only, and thus are not limitative of the present disclosure, and wherein:

FIG. 1 is a block diagram schematically showing the configuration of a sound space construction device according to a first embodiment.

FIG. 2 is a block diagram schematically showing the configuration of an audio extraction unit.

FIG. 3 is a block diagram schematically showing the configuration of a computer.

FIG. 4 shows a first example for explaining a processing example accompanying a movement of an auditory position.

FIG. 5 shows a second example for explaining the processing example accompanying the movement of the auditory position.

FIG. 6 shows a third example for explaining the processing example accompanying the movement of the auditory position.

FIG. 7 is a block diagram schematically showing the configuration of a sound space construction system according to a second embodiment.

FIG. 8 is a block diagram schematically showing the configuration of a sound collection device in the second embodiment.

FIG. 9 is a block diagram schematically showing the configuration of a sound space construction device in the second embodiment.

FIG. 10 is a block diagram schematically showing the configuration of a sound space construction device according to a third embodiment.

### DETAILED DESCRIPTION OF THE INVENTION

### First Embodiment

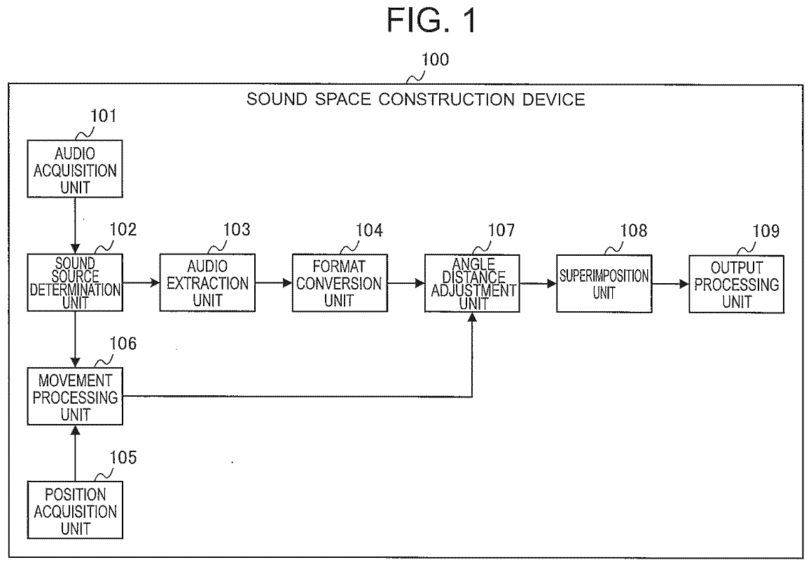

FIG. 1 is a block diagram schematically showing the configuration of a sound space construction device 100 according to a first embodiment.

The sound space construction device 100 includes an audio acquisition unit 101, a sound source determination unit 102, an audio extraction unit 103, a format conversion unit 104, a position acquisition unit 105, a movement processing unit 106, an angle distance adjustment unit 107, a superimposition unit 108 and an output processing unit 109.

The audio acquisition unit 101 acquires audio data including audio from a plurality of sound sources.

For example, the audio acquisition unit 101 acquires audio data generated by a sound collection device (not shown) such as a microphone. While the audio in the audio data is desired to be captured by an Ambisonics microphone as a microphone supporting the Ambisonics method, the audio in the audio data may also be captured by a plurality of omnidirectional microphones. Further, the audio acquisition unit 101 may acquire the audio data from a sound collection device via a not-shown connection I/F (InterFace), or acquire the audio data from a network such as the Internet via a not-shown communication I/F. The acquired audio data is provided to the sound source determination unit 102.

The sound source determination unit 102 determines a plurality of sound source positions as the positions of the plurality of sound sources based on the audio data.

For example, the sound source determination unit 102 performs sound source number determination of determining the number of sound sources included in the audio data and sound source position estimation of estimating the sound source positions as the positions of the sound sources included in the audio data.

A publicly known technology may be used for the sound source number determination. For example, in Reference 1 listed later, a sound source number estimation method by means of independent component analysis is described as the sound source number determination.

Further, the sound source determination unit 102 may identify the sound sources by analyzing an image represented by image data acquired from a not-shown image capturing device such as a camera and determine the number of the sound sources. In other words, the sound source determination unit 102 may determine the plurality of sound source positions by using an image obtained by photographing a space including the plurality of sound sources. For example, the position of an object as a sound source can be determined based on a direction and size of the object.

A publicly known technology may be used also for the sound source position estimation. For example, in Reference 2 listed later, a sound source position estimation method by means of a beam forming method and a MUSIC method are described.

The audio data and sound source number data indicating the sound source number obtained by performing the sound source number determination on the audio data are provided to the audio extraction unit 103.

Sound source position data indicating the sound source positions obtained by the sound source position estimation is provided to the movement processing unit 106.

The audio extraction unit 103 generates a plurality of pieces of extraction audio data by extracting audio represented by the audio data in regard to each sound source and generating the extraction audio data representing the extracted audio. The plurality of pieces of extraction audio data correspond respectively to the plurality of sound sources.

For example, from the audio data, the audio extraction unit 103 extracts the extraction audio data as audio data in regard to each sound source. Specifically, the audio extraction unit 103 generates the extraction audio data corresponding to one sound source included in the plurality of sound sources, among the plurality of pieces of extraction audio data, by subtracting data remaining after separating the audio from the one sound source from the audio data, from the audio data. The extraction audio data are provided to the format conversion unit 104.

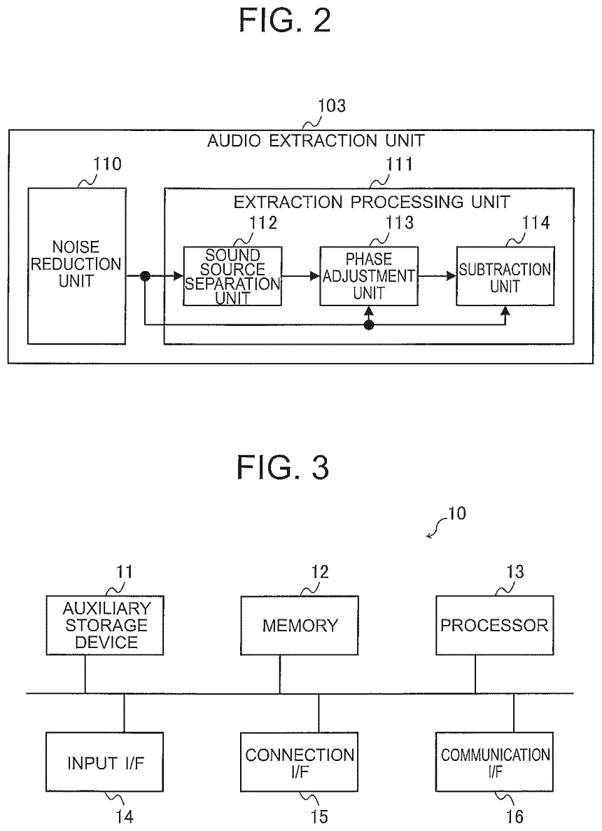

FIG. 2 is a block diagram schematically showing the configuration of the audio extraction unit 103.

The audio extraction unit 103 includes a noise reduction unit 110 and an extraction processing unit 111.

The noise reduction unit 110 reduces noise in the audio data. A publicly known technology may be used as the noise reduction method. For example, the noise reduction unit 110 may reduce the noise by using a GSC (Global Sidelobe Canceller) described in Reference 5 listed later. Processed audio data obtained by reducing the noise in the audio data is provided to the extraction processing unit 111.

The extraction processing unit 111 extracts the extraction audio data, as the audio data in regard to each sound source, from the processed audio data.

The extraction processing unit 111 includes a sound source separation unit 112, a phase adjustment unit 113 and a subtraction unit 114.

The sound source separation unit 112 generates separation audio data by separating the audio data in regard to each sound source from the processed audio data. As the method for separating the audio data in regard to each sound source, a publicly known technology may be used. For example, the sound source separation unit 112 performs the separation by using a technology named ILRMA (Independent Low-Rank Matrix Analysis) described in Reference 3 listed later.

The phase adjustment unit 113 generates phase-adjusted audio data by extracting a phase rotation given in regard to each sound source in the signal processing used for the sound source separation in the sound source separation unit 112 and giving a phase rotation on the opposite side, for canceling the extracted phase rotation, to the processed audio data. The phase-adjusted audio data is provided to the subtraction unit 114.

The subtraction unit 114 extracts the extraction audio data, as the audio data in regard to each sound source, by subtracting the phase-adjusted audio data from the processed audio data in regard to each sound source.

With reference to FIG. 1 again, the format conversion unit 104 generates a plurality of stereophonic sounds corresponding to the plurality of sound sources by converting the format of the plurality of pieces of extraction audio data to the format of stereophonic audio.

For example, the format conversion unit 104 converts the extraction audio data to a stereophonic audio format. In this example, the format conversion unit 104 generates stereophonic sound data representing the stereophonic sounds by converting the format of the extraction audio data to the Ambisonics B- format as the stereophonic audio format.

Incidentally, when the audio has been captured by an Ambisonics microphone, the format conversion unit 104 may convert the Ambisonics A-format of the extraction audio data to the Ambisonics B-format. As the conversion method from the Ambisonics A-format to the Ambisonics B-format, a publicly known technology may be used. For example, a conversion method from the Ambisonics A-format to the Ambisonics B-format is described in the Reference 4 listed later.

In contrast, when the audio has been captured by a plurality of omnidirectional microphones, the format conversion unit 104 may convert the format of the extraction audio data to the Ambisonics B-format by using a publicly known technology. For example, a method of generating audio data of the Ambisonics B-format by generating bidirectionality by performing beam forming on the result of sound collection by an omnidirectional microphone is described in Reference 5 listed later.

The position acquisition unit 105 acquires an auditory position as the position where audio is listened to. For example, the position acquisition unit 105 acquires the auditory position by receiving designation of the auditory position, where a user listens to the audio in a virtual space, from the user via a not-shown input I/F such as a mouse or a keyboard. In this example, the user is assumed to be able to move in the virtual space, and thus the position acquisition unit 105 acquires the auditory position periodically or upon each detection of movement of the user.

Then, the position acquisition unit 105 provides position data indicating the acquired auditory position to the movement processing unit 106.

The movement processing unit 106 calculates an angle and a distance between the auditory position and each of the plurality of sound source positions.

For example, the movement processing unit 106 calculates the angle and the distance between the auditory position and each sound source position based on the auditory position indicated by the position data and the sound source position indicated by the sound source position data. Then, the movement processing unit 106 provides angle distance data, indicating the calculated angle and distance in regard to each sound source, to the angle distance adjustment unit 107.

The angle distance adjustment unit 107 adjusts each of the plurality of stereophonic sounds by using the angle and the distance corresponding to each of the plurality of sound source positions and thereby generates a plurality of adjusted stereophonic sounds as a plurality of stereophonic sounds at the auditory position.

For example, the angle distance adjustment unit 107 adjusts the stereophonic sound data in regard to each sound source so as to satisfy the angle and the distance indicated by the angle distance data.

For example, the angle distance adjustment unit 107 is capable of easily changing the angle corresponding to an arrival direction of the sound from the sound source in the Ambisonics B-format according to specifications of Ambisonics.

Further, the angle distance adjustment unit 107 adjusts the amplitude in the stereophonic sound data according to the distance indicated by the angle distance data. For example, if the distance between the auditory position and the sound source is ½ of the distance between the sound source and a capture position at the time when the audio data is acquired, the angle distance adjustment unit 107 increases the amplitude by 6 dB. In other words, the angle distance adjustment unit 107 may adjust the relationship between the distance and the amplitude according to the square law, for example.

The angle distance adjustment unit 107 provides adjusted stereophonic sound data, representing the adjusted stereophonic sounds as the stereophonic sounds in which the angle and the distance are adjusted in regard to each sound source, to the superimposition unit 108.

The superimposition unit 108 superimposes the plurality of adjusted stereophonic sounds together.

For example, the superimposition unit 108 superimposes together the adjusted stereophonic sound data in regard to the respective sound sources. Specifically, the superimposition unit 108 adds up sound signals respectively represented by the adjusted stereophonic sound data in regard to the respective sound sources. By this method, the superimposition unit 108 generates synthetic sound data indicating the sound signals added up. The synthetic sound data is provided to the output processing unit 109.

The output processing unit 109 generates output sound data representing output sounds by converting channel-based sounds represented by the synthetic sound data to binaural sounds as sounds for the listening by both ears. As the method for converting the channel-based sounds to the binaural sounds, a publicly known technology may be used. For example, a method for converting the channel-based sounds to the binaural sounds is described in Reference 6 listed later.

Then, the output processing unit 109 outputs the output sound data to an audio output device such as speakers via a not-shown connection I/F, for example. Alternatively, the output processing unit 109 outputs the output sound data to an audio output device such as speakers via a not-shown communication I/F.

The sound space construction device 100 described above can be implemented by a computer 10 like the one shown in FIG. 3.

The computer 10 includes, for example, an auxiliary storage device 11 such as an HDD (Hard Disk Drive) or an SSD (Solid State Drive), a memory 12, a processor 13 such as a CPU (Central Processing Unit), an input I/F 14 such as a keyboard or a mouse, a connection I/F 15 according to USB (Universal Serial Bus) or the like, and a communication I/F 16 such as a NIC (Network Interface Card).

Specifically, the audio acquisition unit 101, the sound source determination unit 102, the audio extraction unit 103, the format conversion unit 104, the position acquisition unit 105, the movement processing unit 106, the angle distance adjustment unit 107, the superimposition unit 108 and the output processing unit 109 can be implemented by the processor 13 loading a program stored in the auxiliary storage device 11 into the memory 12 and executing the program.

The program may be downloaded to the auxiliary storage device 11 from a record medium via a not-shown reader/writer or from a network via the communication I/F 16 and then loaded into the memory 12 and executed by the processor 13. The program may also be directly loaded into the memory 12 from a record medium via a reader/writer or from a network via the communication I/F 16 and then executed by the processor 13. The processor 13 is an example of processing circuitry. The memory 12 is an example of a non-transitory computer-readable storage medium storing the program.

In the Ambisonics method, the arrival direction of the sound from the sound source can be changed corresponding to the direction the user is facing.

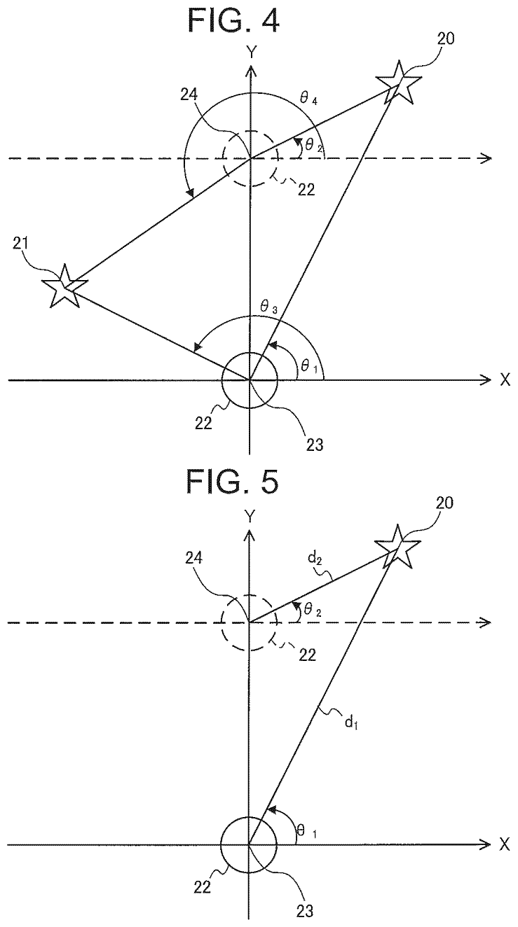

However, when there are a plurality of sound sources such as a first sound source 20 and a second sound source 21 as shown in FIG. 4, if a user 22 moves from a first auditory position 23 to a second auditory position 24, the angle between the user 22 and the first sound source 20 changes from the angle θ₁ to the angle θ₂ and the angle between the user 22 and the second sound source 21 changes from the angle θ₃ to the angle θ₄.

In the conventional Ambisonics method, it is impossible to change the angle in regard to each sound source as shown in FIG. 4 although a uniform angle change such as a change in the direction of the user is possible.

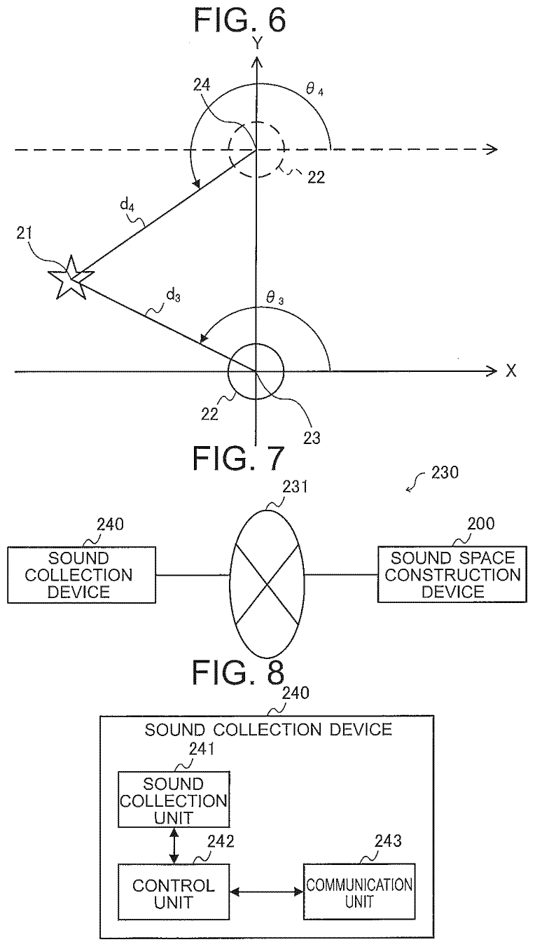

Therefore, in the first embodiment, the process is executed by extracting the extraction audio data from the first sound source 20 and the extraction audio data from the second sound source 21 from the audio data as shown in FIG. 5 and FIG. 6, for example.

Specifically, as shown in FIG. 5, when the user 22 moves from the first auditory position 23 to the second auditory position 24, the first embodiment changes the angle between the user 22 and the first sound source 20 from a first angle ν₁ to a second angle θ₂. The first embodiment also changes the intensity of the sound from the first sound source 20 depending on the change from a first distance d₁ between the first auditory position 23 and the first sound source 20 to a second distance d₂ between the second auditory position 24 and the first sound source 20.

Further, as shown in FIG. 6, when the user 22 moves from the first auditory position 23 to the second auditory position 24, the first embodiment changes the angle between the user 22 and the second sound source 21 from a third angle θ₃ to a fourth angle θ₄. The first embodiment also changes the intensity of the sound from the second sound source 21 depending on the change from a third distance d₃ between the first auditory position 23 and the second sound source 21 to a fourth distance d₄ between the second auditory position 24 and the second sound source 21.

Then, the first embodiment changes the sound accompanying the movement of the user by superimposing together the data respectively processed in regard to the respective sound sources as described above.

Therefore, according to the first embodiment, the sound field at a free position in the virtual space can be reproduced even when there exist a plurality of sound sources.

### Second Embodiment

FIG. 7 is a block diagram schematically showing the configuration of a space construction system 230 according to a second embodiment.

The sound space construction system 230 includes a sound space construction device 200 and a sound collection device 240.

The sound space construction device 200 and the sound collection device 240 are connected to each other by a network 231 such as the Internet.

The sound collection device 240 captures audio in a space separate from the sound space construction device 200 and transmits audio data representing the audio to the sound space construction device 200 via the network 231.

FIG. 8 is a block diagram schematically showing the configuration of the sound collection device 240.

The sound collection device 240 includes a sound collection unit 241, a control unit 242 and a communication unit 243.

The sound collection unit 241 captures audio in a space in which the sound collection device 240 is installed. The sound collection unit 241 can be formed of an Ambisonics microphone or a plurality of omnidirectional microphones, for example.

The control unit 242 controls processing in the sound collection device 240.

For example, the control unit 242 generates audio data representing the audio captured by the sound collection unit 241 and transmits data to the sound space construction device 200 via the communication unit 243.

Further, when a direction for capturing audio is instructed from the sound space construction device 200 via the communication unit 243, the control unit 242 generates audio data representing audio from that by direction controlling the sound collection unit 241 and transmits the audio data to the sound space construction device 200. This is a process when beam forming is performed by the sound space construction device 200.

Part or the whole of the control unit 242 described above can be formed of a memory and a processor such as a CPU (Central Processing Unit) executing a program stored in the memory although not shown in the figure. Such a program may be provided via a network, or provided in the form of being stored in a record medium. Namely, such a program may be provided as a program product, for example.

Further, part or the whole of the control unit 242 can also be formed of a processing circuit such as a single circuit, a combined circuit, a processor operating according to a program, a parallel processor operating according to a program, an ASIC (Application Specific Integrated Circuit), or an FPGA (Field Programmable Gate Array) although not shown in the figure.

As above, the control unit 242 can be implemented by a processing circuit network.

The communication unit 243 executes communication with the sound space construction device 200 via the network 231.

For example, the communication unit 243 transmits the audio data to the sound space construction device 200 via the network 231.

Further, the communication unit 243 receives an instruction from the sound space construction device 200 via the network 231 and provides the instruction to the control unit 242.

Here, the communication unit 243 can be implemented by a communication I/F such as a NIC although not shown in the figure.

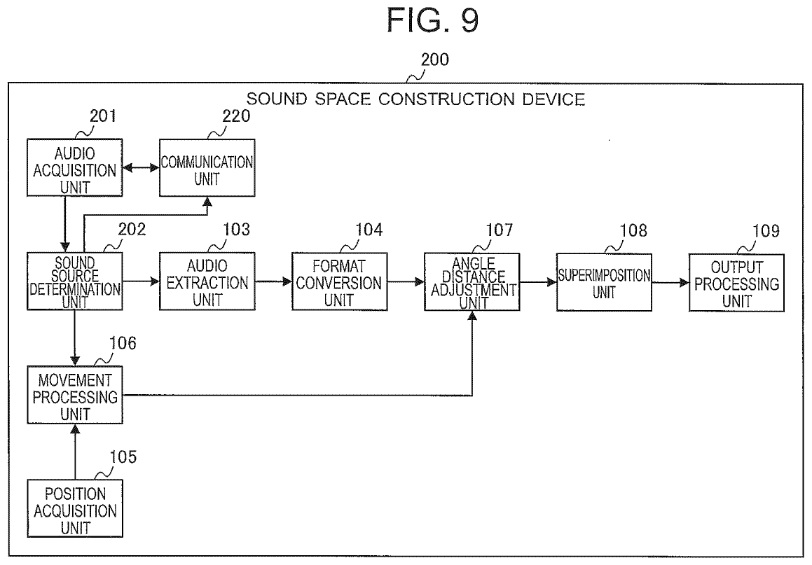

FIG. 9 is a block diagram schematically showing the configuration of the sound space construction device 200 in the second embodiment.

The sound space construction device 200 includes an audio acquisition unit 201, a sound source determination unit 202, the audio extraction unit 103, the format conversion unit 104, the position acquisition unit 105, the movement processing unit 106, the angle distance e adjustment unit 107, the superimposition unit 108, the output processing unit 109 and a communication unit 220.

The audio extraction unit 103, the format conversion unit 104, the position acquisition unit 105, the movement processing unit 106, the angle distance adjustment unit 107, the superimposition unit 108 and the output processing unit 109 in the sound space construction device 200 in the second embodiment are the same as the audio extraction unit 103, the format conversion unit 104, the position acquisition unit 105, the movement processing unit 106, the angle distance adjustment unit 107, the superimposition unit 108 and the output processing unit 109 in the sound space construction device 100 in the first embodiment.

The communication unit 220 executes communication with the sound collection device 240 via the network 231.

For example, the communication unit 220 receives the audio data from the sound collection device 240 via the network 231.

Further, the communication unit 220 transmits an instruction to the sound collection device 240 via the network 231.

Incidentally, the communication unit 220 can be implemented by the communication I/F 16 shown in FIG. 3.

The audio acquisition unit 201 acquires the audio data from the sound collection device 240 via the communication unit 220. The acquired audio data is provided to the sound source determination unit 202. In the second embodiment, the audio data is data representing the audio captured by the sound collection device 240 connected to the sound space construction device 200 by the network 231.

The sound source determination unit 202 performs the sound source number determination of determining the number of sound sources included in the audio data and the sound source position estimation of estimating the sound source positions as the positions of the sound sources included in the audio data. The sound source number determination and the sound source position estimation may be performed according to the same processes as those in the first embodiment.

Incidentally, when the sound source determination unit 202 performs the sound source position estimation by means of the beam forming method and the MUSIC method, for example, the sound source determination unit 202 transmits an instruction indicating the direction for capturing audio to the sound collection device 240 via the communication unit 220.

As described above, according to the second embodiment, a virtual space can be constructed by using audio transmitted from a remote location by installing the sound collection device 240 in the remote location.

### Third Embodiment

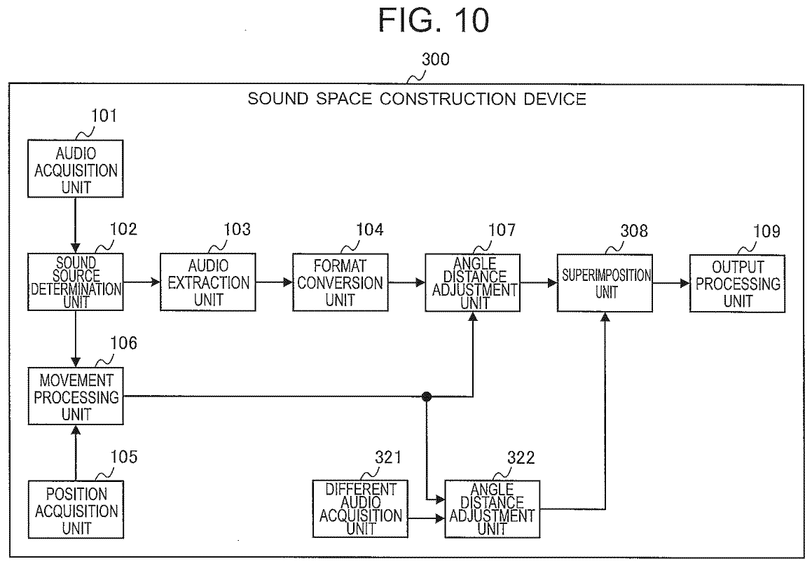

FIG. 10 is a block diagram schematically showing the configuration of a sound space construction device 300 according to a third embodiment.

The sound space construction device 300 includes the audio acquisition unit 101, the sound source determination unit 102, the audio extraction unit 103, the format conversion unit 104, the position acquisition unit 105, the movement processing unit 106, the angle distance adjustment unit 107, a superimposition unit 308, the output processing unit 109, a different audio acquisition unit 321 and an angle distance adjustment unit 322.

The audio acquisition unit 101, the sound source determination unit 102, the audio extraction unit 103, the format conversion unit 104, the position acquisition unit 105, the movement processing unit 106, the angle distance adjustment unit 107 and the output processing unit 109 in the sound space construction device 300 according to the third embodiment are the same as the audio acquisition unit 101, the sound source determination unit 102, the audio extraction unit 103, the format conversion unit 104, the position acquisition unit 105, the movement processing unit 106, the angle distance adjustment unit 107 and the output processing unit 109 in the sound space construction device 100 according to the first embodiment.

However, the movement processing unit 106 provides the angle distance data also to the angle distance adjustment unit 322.

The different audio acquisition unit 321 acquires audio data generated by a sound collection device (not shown) such as a microphone. The audio data acquired by the different audio acquisition unit 321 is assumed to be audio data different from the audio data acquired by the audio acquisition unit 101 in at least one of the time and the position of the capture. The audio data acquired by the different audio acquisition unit 321 is referred to also as superimposition-dedicated audio data.

Here, the superimposition-dedicated audio data is assumed to be data that has undergone the separation in regard to the respective sound sources and the conversion to the Ambisonics B-format by the same processing as the processing by the sound source determination unit 102, the audio extraction unit 103 and the format conversion unit 104 in the first embodiment.

In other words, the different audio acquisition unit 321 acquires the superimposition-dedicated audio data representing superimposition-dedicated stereophonic sound as stereophonic sound generated by converting the audio data of the audio, different from the audio included in the audio data acquired by the audio acquisition unit 101 in at least one of the time and the position of the capture, to the stereophonic audio format.

While the audio in the superimposition-dedicated audio data is desired to be captured by an Ambisonics microphone as a microphone supporting the Ambisonics method, the audio in the superimposition-dedicated audio data may also be captured by a plurality of omnidirectional microphones. The different audio acquisition unit 321 may also acquire the audio data from a sound collection device via a not-shown connection I/F, or acquire the audio data from a network such as the Internet via a not-shown communication I/F. Further, the different audio acquisition unit 321 may also acquire the superimposition-dedicated audio data from a not-shown storage unit. The acquired superimposition-dedicated audio data is provided to the angle distance adjustment unit 322.

The angle distance adjustment unit 322 functions as a superimposition-dedicated angle distance adjustment unit that generates superimposition-dedicated adjusted stereophonic sound as stereophonic sound at the auditory position from the superimposition-dedicated stereophonic sound.

The angle distance adjustment unit 322 adjusts the superimposition-dedicated audio data in regard to each sound source so as to satisfy the angle and the distance indicated by the angle distance data. For example, when the superimposition-dedicated audio data represents audio in the past at the same place as the audio in the audio data acquired by the audio acquisition unit 101, the angle distance adjustment unit 322 may adjust the angle and the amplitude according to the angle distance data. The method of adjusting the angle and the amplitude is the same as the adjustment method of the angle distance adjustment unit 107 in the first embodiment.

In contrast, when the superimposition-dedicated audio data represents audio at a place different from the place of the audio in the audio data acquired by the audio acquisition unit 101, there has previously been set a standard for adjusting the angle and the amplitude in regard to each sound source according to the angle and the distance indicated by the angle distance data, and the angle distance adjustment unit 322 may adjust the angle and the amplitude in the superimposition-dedicated audio data according to the standard.

The angle distance adjustment unit 322 provides superimposition-dedicated adjusted audio data, representing the superimposition-dedicated adjusted stereophonic sound as the superimposition-dedicated stereophonic sound after undergoing the adjustment of the angle and the distance in regard to each sound source, to the superimposition unit 308.

The superimposition unit 308 superimposes together the plurality of adjusted stereophonic sounds and the superimposition-dedicated adjusted stereophonic sound.

For example, the superimposition unit 308 superimposes together the adjusted stereophonic sound data in regard to the respective sound sources and the superimposition-dedicated adjusted audio data. Specifically, the superimposition unit 308 adds up the sound signals respectively represented by the adjusted stereophonic sound data in regard to the respective sound sources and a sound signal represented by the superimposition-dedicated adjusted audio data. By this method, the superimposition unit 308 generates the synthetic sound data indicating the sound signals added up. The synthetic sound data is provided to the output processing unit 109.

The different audio acquisition unit 321 and the angle distance adjustment unit 322 described above can also be implemented by the processor 13 shown in FIG. 3 loading a program stored in the auxiliary storage device 11 into the memory 12 and executing the program.

As described above, according to the third embodiment, even different audio that does not occur in reality can be added to the virtual space, and thus the value of remote traveling or the like can be increased, for example. Specifically, the user can listen to audio in the past at the auditory position in the virtual space or audio in a space different from the virtual space. For example, the user can listen to audio recorded in Shuri Castle, which no longer exists today, in the virtual space.
Reference 1: Sawada et al., “Sound Source Number Estimation Method by Using Independent Component Analysis”, Proceedings of the Autumn Meeting of the Acoustical Society of Japan, 2004
Reference 2: Futoshi Asano, “Array Signal Processing of Sound—Localization/Tracking and Separation of Sound Source”, chapters 4 and 5, Corona Publishing Co., Ltd., 2011
Reference 3: Kitamura et al., “Blind Source Separation Based on Independent Low-rank Matrix Analysis”, IEICE Technical Report, EA2017-56, vol.117, No.255, pp.73-80, Toyama, October 2017
Reference 4: Ryouichi Nishimura “Ambisonics”, The Journal of the Institute of Image Information and Television Engineers, Vol. 68, No. 8, pp.616-620, 2014
Reference 5: Japanese Patent No. 6742535
Reference 6: Japanese Patent No. 4969978

### DESCRIPTION OF REFERENCE CHARACTERS

100, 200, 300: sound space construction device, 101, 201: audio acquisition unit, 102, 202: sound source determination unit, 103: audio extraction unit, 104: format conversion unit, 105: position acquisition unit, 106: movement processing unit, 107: angle distance adjustment unit, 108, 308: superimposition unit, 109: output processing unit, 110: noise reduction unit, 111: extraction processing unit, 112: sound source separation unit, 113: phase adjustment unit, 114: subtraction unit, 220: communication unit, 321: different audio acquisition unit, 322: angle distance adjustment unit, 230: sound space construction system, 231: network, 240: sound collection device, 241: sound collection unit, 242: control unit, 243: communication unit.

What is claimed is:

1. A sound space construction device comprising processing circuitry:
to acquire audio data including audio from a plurality of sound sources;
to determine a plurality of sound source positions as positions of the plurality of sound sources based on the audio data;
to generate a plurality of pieces of extraction audio data by extracting audio represented by the audio data in regard to each sound source and generating the extraction audio data representing the extracted audio;
to generate a plurality of stereophonic sounds corresponding to the plurality of sound sources by converting a format of the plurality of pieces of extraction audio data to a format of stereophonic audio;
to acquire an auditory position as a position where audio is listened to;
to calculate an angle and a distance between the auditory position and each of the plurality of sound source positions;
to adjust each of the plurality of stereophonic sounds by using the angle and the distance corresponding to each of the plurality of sound source positions and thereby generate a plurality of adjusted stereophonic sounds as a plurality of stereophonic sounds at the auditory position; and
to superimpose the plurality of adjusted stereophonic sounds together.

2. The sound space construction device according to claim 1, wherein the processing circuitry generates the extraction audio data corresponding to one sound source included in the plurality of sound sources, among the plurality of pieces of extraction audio data, by subtracting data remaining after separating the audio from the one sound source from the audio data, from the audio data.

3. The sound space construction device according to claim 1, wherein processing circuitry determines the plurality of sound source positions by using an image obtained by photographing a space including the plurality of sound sources.

4. The sound space construction device according to claim 1, wherein the audio data is data representing audio captured by a sound collection device connected to the sound space construction device by a network.

5. The sound space construction device according to claim 1, wherein the processing circuitry further:
acquires superimposition-dedicated audio data representing superimposition-dedicated stereophonic sound as stereophonic sound generated by converting audio data of audio, different from the audio included in the acquired audio data in at least one of a time and a position of capture, to the format of stereophonic audio; and
generates superimposition-dedicated adjusted stereophonic sound as stereophonic sound at the auditory position from the superimposition-dedicated stereophonic sound,
wherein the processing circuitry superimposes together the plurality of adjusted stereophonic sounds and the superimposition-dedicated adjusted stereophonic sound.

6. A sound space construction system comprising the sound space construction device according to claim 1 and a sound collection device that is connected to the sound space construction device by a network and generates audio data including audio from a plurality of sound sources.

7. A non-transitory computer-readable storage medium storing a program that causes a computer to execute processing:
to acquire audio data including audio from a plurality of sound sources;
to determine a plurality of sound source positions as positions of the plurality of sound sources based on the audio data;
to generate a plurality of pieces of extraction audio data by extracting audio represented by the audio data in regard to each sound source and generating the extraction audio data representing the extracted audio;
to generate a plurality of stereophonic sounds corresponding to the plurality of sound sources by converting a format of the plurality of pieces of extraction audio data to a format of stereophonic audio;
to acquire an auditory position as a position where audio is listened to;
to calculate an angle and a distance between the auditory position and each of the plurality of sound source positions;
to adjust each of the plurality of stereophonic sounds by using the angle and the distance corresponding to each of the plurality of sound source positions and thereby generate a plurality of adjusted stereophonic sounds as a plurality of stereophonic sounds at the auditory position; and
to superimpose the plurality of adjusted stereophonic sounds together.

8. A sound space construction method comprising:
acquiring audio data including audio from a plurality of sound sources;
determining a plurality of sound source positions as positions of the plurality of sound sources based on the audio data;
generating a plurality of pieces of extraction audio data by extracting audio represented by the audio data in regard to each sound source and generating the extraction audio data representing the extracted audio;
generating a plurality of stereophonic sounds corresponding to the plurality of sound sources by converting a format of the plurality of pieces of extraction audio data to a format of stereophonic audio;
acquiring an auditory position as a position where audio is listened to;
calculating an angle and a distance between the auditory position and each of the plurality of sound source positions;
adjusting each of the plurality of stereophonic sounds by using the angle and the distance corresponding to each of the plurality of sound source positions and thereby generating a plurality of adjusted stereophonic sounds as a plurality of stereophonic sounds at the auditory position; and
superimposing the plurality of adjusted stereophonic sounds together.
